(19) United States
(12) Patent Application Publication
(10) Pub. No.: US 2007/0146299 A1
(43) Pub. Date: Jun. 28, 2007

(54) Liquid crystal display and method for driving the same

(75) Inventors: Ki Duk Kim, Gyeonggi-do (KR); Jae kyeong Yun, Gyeonggi-do (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd.

(21) Appl. No.: 11/593,029

(22) Filed: Nov. 6, 2006

(30) Foreign Application Priority Data
Dec. 28, 2005 (KR) 2005-0132131

(51) Int. Cl. G09G 3/36

(52) U.S. Cl. 345/102

(57) ABSTRACT

A liquid crystal display is disclosed. The disclosed liquid crystal display includes a driver circuit configured to generate at least one liquid crystal driving pulse and at least one backlight driving pulse. The liquid crystal driving pulse includes a normal data signal and a blanking signal, and the backlight driving pulse includes an active signal and a reference signal. The liquid crystal display also includes a backlight unit configured to generate light in response to the backlight driving pulse and a liquid crystal panel configured to display an image having a light transmittance that varies depending upon the liquid crystal driving pulse and the backlight driving pulse.

This application claims the benefit of the Korean Patent Application No. 2005-0132131 filed on Dec. 28, 2005, which is hereby incorporated by reference.

### BACKGROUND OF THE INVENTION

1. Field of the Invention

The present invention relates to a liquid crystal display and a method for driving the same and, more specifically, a liquid crystal display and a method for driving the same with improved display characteristics.

2. Description of the Related Art

Generally, a liquid crystal display (LCD) is a display device in which liquid crystal material with an anisotropic dielectric constant is injected between an upper transparent insulating substrate and a lower transparent insulating substrate. Molecular arrangement of the liquid crystal material is changed by the intensity of the electric field applied to the liquid crystal material such that the amount of light, which is generated from a backlight unit, transmitted through the transparent insulating substrates may be controlled, and thereby a desired image may be displayed. A thin film transistor liquid crystal display (TFT LCD) using a TFT as a switching device is a type of LCD that is widely used.

In a liquid crystal display, a plurality of gate lines are arranged in a first direction, and a plurality of data lines are arranged in a second direction which is substantially perpendicular to the first direction. A thin film transistor and a pixel electrode are arranged in a region where a gate line and a data line intersect each other, and a liquid crystal capacitor and a storage capacitor are arranged in the region.

When the thin film transistor is turned on in response to a scan pulse applied to a gate line, a gamma voltage corresponding to video data is applied from the data lines to each of the pixels corresponding to the gate line. The video data correspond to a digital signal representing a gray level. For example, the gray level may be between 0 and 255.

Thus, an electric field is generated due to a voltage difference between the gamma voltage applied to a pixel electrode and a common voltage applied to the common electrode. The electric field is applied to a liquid crystal layer such that the light, e.g., from the backlight unit, is transmitted through the liquid crystal. The transmittance of the light is determined by the intensity of the applied electric field. Furthermore, the storage capacitor maintains the gamma voltage applied to the pixel electrode during one frame so that an image is maintained in the pixel for one frame.

When the liquid crystal display is driven as detailed above, an over-driving method may be used. In the over-driving method, the video data having a higher value than a normal value are applied to each of the pixels so as to compensate for a delayed (or slow) response of the liquid crystal.

FIG. 1 illustrates graphs showing light-transmission characteristics of liquid crystal and final light-transmission characteristics of a liquid crystal display according to a related art. As shown in FIG. 1, graphs (a) and (b) respectively illustrate a normal driving method and an over-driving method. In FIG. 1, light-transmission characteristics of liquid crystal and final light-transmission characteristics of a liquid crystal display are shown in a unit frame when a backlight driving pulse G1 and a liquid crystal driving pulse G2 are applied to the liquid crystal display.

When the liquid crystal display is driven by the normal driving method, the light-transmission characteristics G3 of the liquid crystal and the final light-transmission characteristics G4 of the liquid crystal display are shown in the graph (a) due to the response time of the liquid crystal. When the liquid crystal display is driven by the over-driving method, the light-transmission characteristics G3 of the liquid crystal and the final light-transmission characteristics G4 of the liquid crystal display are improved as shown in the graph (b) due to a faster response time of the liquid crystal.

When a gamma voltage applied to the liquid crystal changes rapidly due to a large difference in pixel data between two consecutive frames, it is difficult to stabilize the voltage level of the gamma voltage within one frame due to the delayed response of the liquid crystal. Accordingly, the response time of the liquid crystal may be improved by using the over-driving method. However, in case of the over-driving method according to the related art, electromagnetic interference increases, and power consumption increases.

### SUMMARY OF THE INVENTION

Accordingly, the present invention is directed to a liquid crystal display device and method for driving the same that substantially obviate one or more of the problems due to limitations and disadvantages of the related art.

The present invention is directed to a liquid crystal display that effectively enhances the response characteristics and brightness of the liquid crystal display. The present invention is also directed to a method for effectively driving the above liquid crystal display.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a liquid crystal display includes a driver circuit configured to generate at least one liquid crystal driving pulse and at least one backlight driving pulse, wherein the liquid crystal driving pulse includes a normal data signal and a blanking signal, and the backlight driving pulse includes an active signal and a reference signal; a backlight unit configured to generate light in response to the backlight driving pulse; and a liquid crystal panel configured to display an image having a light transmittance that varies depending upon the liquid crystal driving pulse and the backlight driving pulse.

In another aspect of the present invention, a method for driving a liquid crystal display includes generating at least one liquid crystal driving pulse, wherein the liquid driving pulse includes a normal data signal and a blanking signal; generating at least one backlight driving pulse, wherein the backlight driving pulse includes an active signal and a reference signal; and displaying an image on the liquid crystal display having a light transmittance that varies depending upon the liquid crystal driving pulse and the backlight driving pulse.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates graphs showing light-transmission characteristics of liquid crystal and final light-transmission characteristics in a related art liquid crystal display;

FIG. 2 illustrates a liquid crystal display according to an embodiment of the present invention;

FIG. 3 illustrates graphs showing light-transmission characteristics of liquid crystal and final light-transmission characteristics of a liquid crystal display according to an embodiment of the present invention;

FIGS. 4 and 5 illustrate graphs showing examples of a reference signal and an active signal of the backlight driving pulse of FIG. 3;

FIG. 6 illustrates graphs showing light-transmission characteristics of liquid crystal and final light-transmission characteristics of a liquid crystal display according to another embodiment of the present invention;

FIGS. 7 and 8 illustrate graphs showing examples of a reference signal and an active signal of the backlight driving pulse of FIG. 6; and

FIG. 9 illustrates a flow chart showing a method for driving a liquid crystal display according to an embodiment of the present invention.

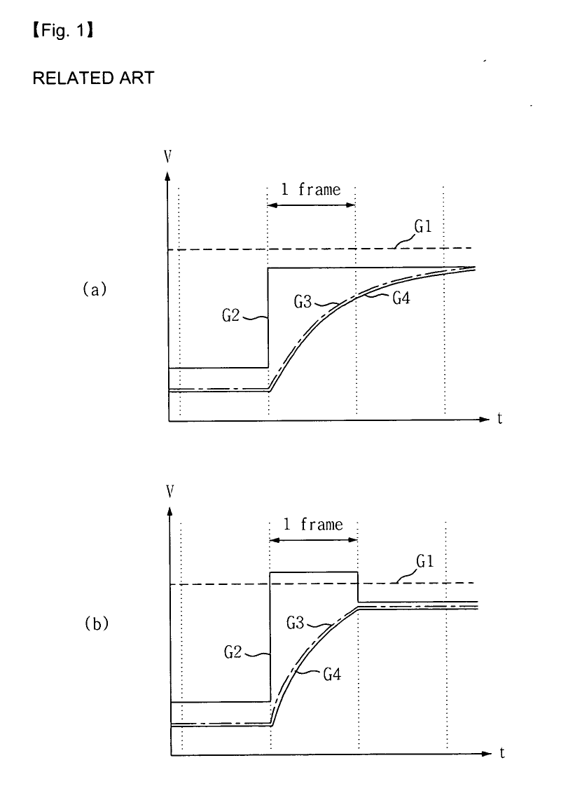

### DETAILED DESCRIPTION OF THE PREFERRED EMBODIMENTS

Reference will now be made in detail to the embodiments of the present invention, examples of which are illustrated in the accompanying drawings.

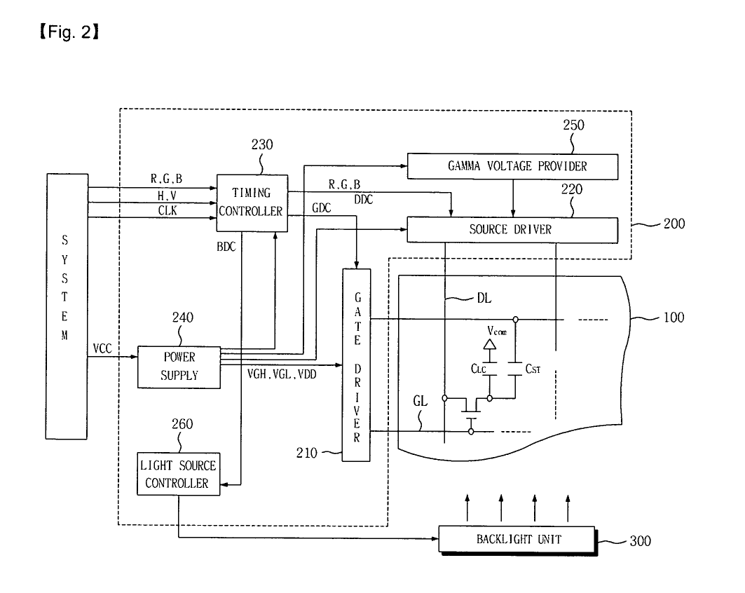

FIG. 2 illustrates a liquid crystal display according to an embodiment of the present invention. As shown in FIG. 2, the liquid crystal display includes a liquid crystal display panel 100, a driver circuit 200 for driving the liquid crystal display panel 100, and a backlight unit 300 for providing light to the liquid crystal display panel 100.

The liquid crystal display panel 100 includes a plurality of pixels having a matrix arrangement. A plurality of gate lines GL are arranged in a first direction, and a plurality of data lines DL are arranged in a second direction substantially perpendicular to the first direction. A pixel is coupled to a gate line GL and a data line. The pixels display an image in response to a plurality of scan pulses that are applied through the gate lines GL and a plurality of liquid crystal driving pulses that are applied through the data lines DL.

A thin film transistor, a liquid crystal capacitor, and a storage capacitor are arranged in a region where a gate line and a data line intersect each other. Each pixel includes a thin film transistor, a liquid crystal capacitor, and a storage capacitor.

The driver circuit 200 includes a gate driver 210, a source driver 220, a timing controller 230, a power supply 240, a gamma voltage provider 250, and a light source controller 260.

The gate driver 210 generates a plurality of scan pulses sequentially applied to the gate lines GL in response to the gate control signal GDC provided from the timing controller 230. The source driver 220 generates a plurality of liquid crystal driving pulses which, in each frame period, includes a normal data signal and a blanking signal.

The normal data signal represents a gamma voltage corresponding to red (R), green (G), and blue (B) video data. The gamma voltage provider 250 provides the gamma voltages. The blanking signal represents a gamma voltage having a black level corresponding to black data.

The source driver 220 selects a gamma voltage corresponding to the red (R), green (G), and blue (B) video data, and generates the liquid crystal driving pulse which includes the selected gamma voltage and the gamma voltage having the black level. The source driver 220 provides the liquid crystal driving pulse to the data lines DL of the liquid crystal panel 100.

The timing controller 230 generates a gate control signal GDC for controlling the gate driver 210 and a data control signal DDC for controlling the source driver 220 based on the video data (R, G, B) provided from an external system (SYS). The timing controller 230 also generates a horizontal synchronization signal H, a vertical synchronization signal V, and clock signal CLK. Additionally, the timing controller 230 provides a light source control signal BDC to the light source controller 260 for controlling the backlight unit 300.

The gate control signal GDC includes a gate start pulse GSP, a gate shift clock signal GSC, and a gate output enable signal GOE. The data control signal DDC includes a source start pulse SSP, a source shift clock signal SSC, a source output enable signal SOC, and a polarity signal POL.

The power supply 240 receives power supply voltage VCC from the external system (SYS) and generates driving voltages having various voltage levels, including a gate high voltage VGH, a gate low voltage VGL, a common voltage Vcom, and a constant voltage VDD.

The gamma voltage provider 250 receives a voltage from the power supply 240, generates gamma voltages (i.e., reference voltages), and provides the gamma voltages to the source driver 220. The source driver 220 performs a digital-to-analog conversion based on the gamma voltages. The voltage levels of the generated gamma voltages include a plurality of gray levels, a white level, and a black level.

The light source controller 260 generates a backlight driving pulse that is synchronized with the liquid crystal driving pulse based on the light source control signal BDC so as to drive the lamp or lamps in the backlight unit 300 according to an embodiment of the present invention. The backlight driving pulse includes an active signal and a reference signal.

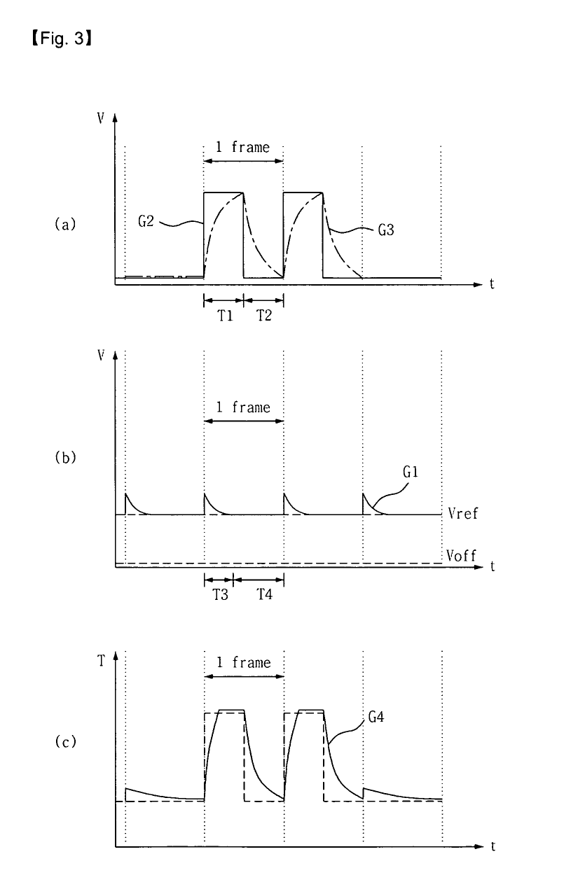

FIG. 3 illustrates graphs showing light-transmission characteristics of liquid crystal and final light-transmission characteristics of a liquid crystal display of FIG. 2 that is driven based on the active lamp method according to an embodiment of the present invention. In particular, FIG. 3 illustrates graphs of light-transmission characteristics of liquid crystal and final light-transmission characteristics of a liquid crystal display that is driven based on active lamp method and a black-data insertion method according to an embodiment of the present invention, in which the brightness of the light source in the backlight unit 300 is actively controlled so that it is periodically increased or decreased.

Graph (a) of FIG. 3 shows the light-transmission characteristics of liquid crystal depending upon a liquid crystal driving pulse G2 when the video data (R, G, and B) have a given value. Graph (b) of FIG. 3 shows a backlight driving pulse G1 when the active lamp method is used. Graph (c) of FIG. 3 shows the final light-transmission characteristics G4 of the liquid crystal display when conditions of the graphs (a) and (b) are provided.

Each frame period of the liquid crystal driving pulse G2 is divided into a data period (T1) and a blanking period (T2). The driver circuit 220 outputs the normal data signal during the data period (T1) and the blanking signal during the blanking period (T2). The light source controller 260 controls the backlight driving pulse G1 based on the light source control signal BDC so that the active signal of the backlight driving pulse G1 is output during the data period (T1).

Each frame period of the backlight driving pulse G1 is divided into an active period (T3) and a reference period (T4). The light source controller 260 outputs the active signal and the reference signal during the active period (T3) and the reference signal during the reference period (T4). The light source control signal BDC allows the active period (T3) of the backlight driving pulse G2 to be within the data period (T1).

The driver circuit 200 divides each frame into first and second periods at a given ratio (for example, 5:5, 6:4, 7:3, etc.), where the first period represents the data period (T1) during which the gamma voltage (i.e., the normal data signal) corresponding to the video data (R, G, and B) is output, and the second period represents the blanking period (T2) during which the gamma voltage having the black level is output.

The backlight unit 300 is driven according to the active lamp method based on the backlight driving pulse G1. The brightness of the light source in the backlight unit is periodically increased or decreased. Each frame period of the backlight driving pulse G1 is divided into an active period (T3), during which the active signal and the reference signal are output, and a reference period (T4), during which the reference signal is output.

The active period (T3) of the backlight driving pulse G1 corresponds to the data period (T1) of the liquid crystal driving pulse G2. The width of the active period (T3) of the backlight driving pulse G1 is narrower than width of the data period (T1) of the liquid crystal driving pulse G2. In particular, the start point and the end point of the active period (T3) of the backlight driving pulse G1 are within the data period (T1) of the liquid crystal driving pulse G2.

When the active lamp method is used, the light transmittance of the liquid crystal display at the rising edges of the liquid crystal driving pulse G2 improves, and therefore, the brightness of the display improves. On the other hand, with only the active lamp method, the light transmittance of the liquid crystal display at the falling edges of the liquid crystal driving pulse G2 may also increase, which can deteriorate the image quality. Thus, the black-data insertion method as the liquid crystal driving method may be simultaneously used with the active lamp method so that the active lamp method increases the final light transmittance of the liquid crystal display at the rising edges of the liquid crystal driving pulse G2 without increasing the response time or the light transmittance at the falling edges.

The time at which the light source controller 260 outputs the active signal may not necessarily correspond to the start point of the data period (T1). The active period (T3) may be experimentally determined by measuring the optimal light efficiency based on when the active signal is provided by the light source controller 260 during the data period (T1).

The start point and the end point of the active period (T3) may be determined based on two considerations. First, the display quality should not deteriorate at the falling edges of the liquid crystal driving pulse G2. Second, the brightness of the light source should be optimally controlled in view of the light transmittance characteristics of the liquid crystal. Thus, the start point and the end point of the active period (T3) should be located within the data period (T1).

If the black-data insertion method is simultaneously used with the active lamp method, when the blanking signal having the black level is inserted and the backlight driving pulse G1 is output during the blanking period (T2) of the present frame of the liquid crystal driving pulse G2, the light transmittance of the liquid crystal display at the rising edge of the liquid crystal driving pulse G2 may improve without an increase in the light transmittance at the falling edge. This is because the liquid crystal driving pulse G2 falls to a zero gray level in the present frame and rises from the zero gray level in the next frame as shown in graph (a) of FIG. 3. The response time at the falling edges decreases because the difference between the data voltage and the blanking data is large. Therefore, the data voltage of the present frame may be prevented from affecting the data voltage of the next frame. This can result in preventing motion blur and improving the image quality of the liquid crystal display.

The liquid crystal panel 100 displays an image having a light transmittance that varies depending upon the liquid crystal driving pulse G2 and the backlight driving pulse G1. The final light-transmission characteristics G4 of the liquid crystal display may be shown as graph (c) of FIG. 3 when the liquid crystal has the light-transmission characteristics G3 based on the liquid crystal driving pulse G2 of graph (a) of FIG. 3 and the brightness of the backlight unit 300 varies according to the backlight driving pulse G1 of graph (b) of FIG. 3.

When the light-transmission characteristics G3 based on the liquid crystal driving pulse G2 of graph (a) of FIG. 3 are compared with the final light-transmission characteristics G4 of graph (c) of FIG. 3 where the backlight driving pulse G1 is applied, the response time of the liquid crystal display at the rising edge of the final light-transmission characteristics G4 is reduced (i.e., enhanced) due to the backlight driving pulse G1 of the active lamp method.

In addition, if the liquid crystal driving pulse G2 is applied to the liquid crystal display according to the black-data insertion method, the falling edge of the final light-transmission characteristics G4 is not affected by the backlight driving pulse G1. Accordingly, the final light transmittance of the liquid crystal display at the falling edge decreases. This results in a decreased response time of the liquid crystal display at the falling edges of the final light transmission characteristics G4. Thus, the data voltage of the present frame can be prevented from affecting the data voltage of the next frame, thereby preventing motion blur.

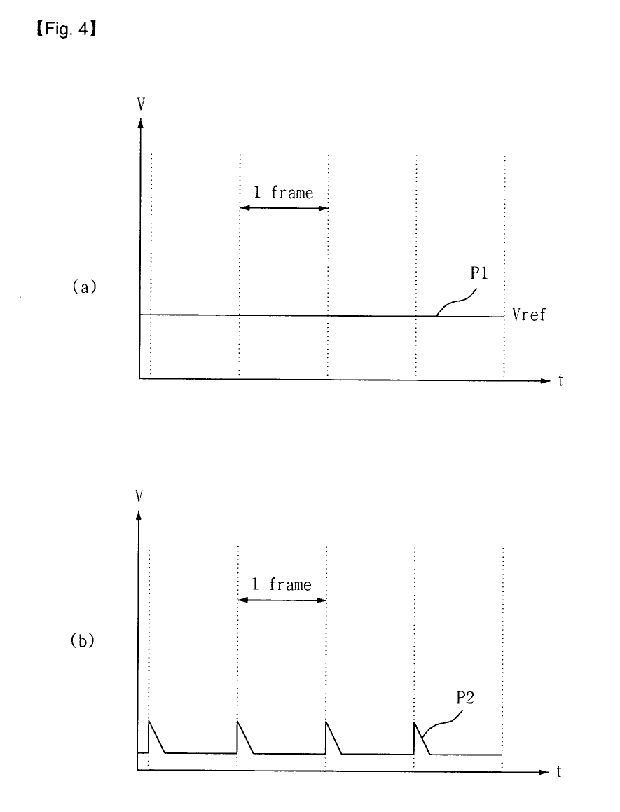

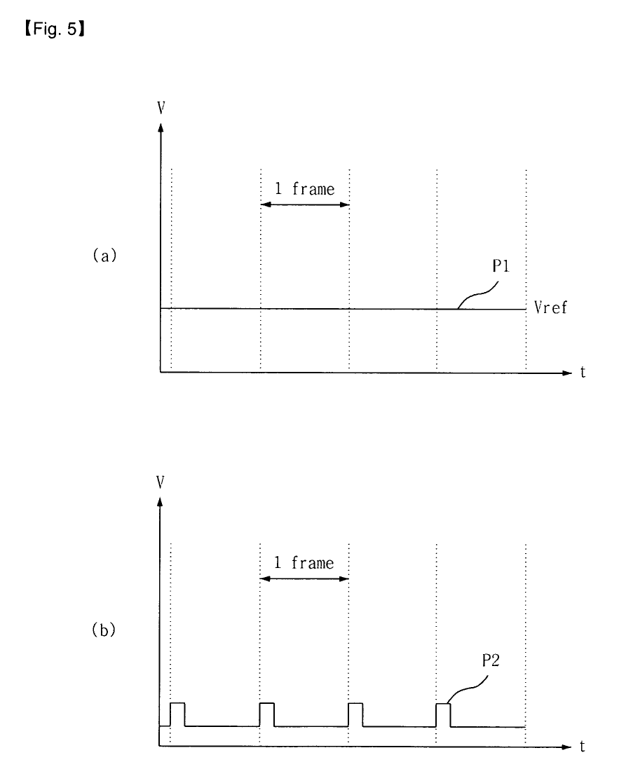

FIGS. 4 and 5 illustrate graphs showing examples of a reference signal and an active signal of the backlight driving pulse of FIG. 3. In the active lamp method, the backlight driving pulse G1 includes the reference signal P1 for turning on the backlight unit 300 and the active signal P2.

FIG. 4 shows an example in which the reference signal P1 has a DC (Direct Current) level Vref and the active signal P2 has a saw-tooth waveform. FIG. 5 shows another example in which the reference signal P1 has the DC level Vref and the active signal P2 has a rectangular waveform. The active signal P2 of the backlight driving pulse G1 may be generated by generating the saw-tooth wave signal or the rectangular wave signal, whose width is substantially narrower than a typical period (e.g., about 16.7 ms) of one frame.

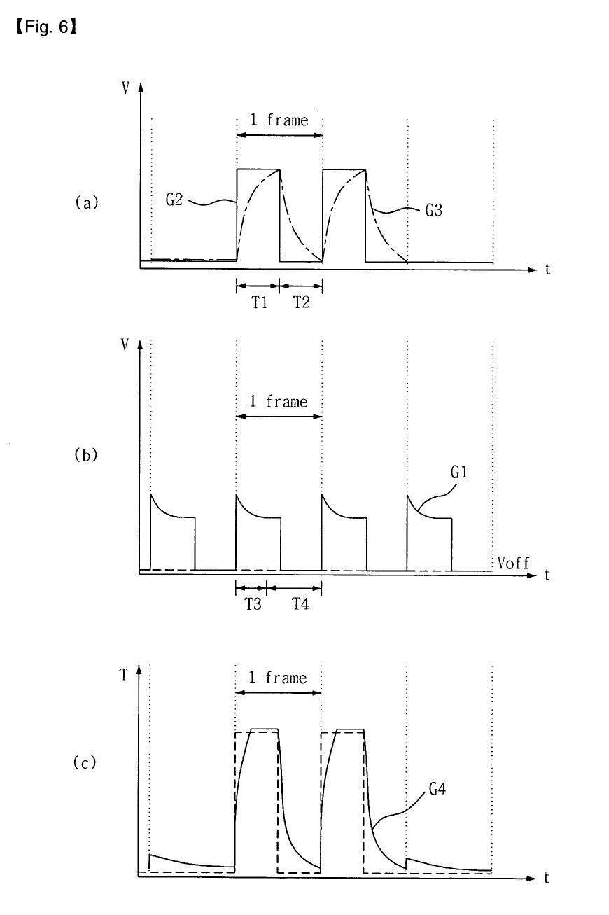

FIG. 6 illustrates graphs showing light-transmission characteristics of liquid crystal and final light-transmission characteristics of a liquid crystal display according to another embodiment of the present invention. In this embodiment, an active lamp method and a scanning backlight method, in which the backlight unit 300 is periodically turned on and off, are used as a backlight driving method, and a black-data insertion method is used as a liquid crystal driving method at the same time.

Graph (a) of FIG. 6 shows light-transmission characteristics G3 of liquid crystal based on a liquid crystal driving pulse G2 when the video data (R, G, and B) have a given value. Graph (b) of FIG. 6 shows a backlight driving pulse G1 when the scanning backlight method is used. Graph (c) of FIG. 6 shows final light-transmission characteristics G4 of the liquid crystal display when conditions of the graphs (a) and (b) are provided. The response time of the liquid crystal display at the rising edge of the final light transmission characteristics G4 of FIG. 6 is shorter (i.e., better) than that at the rising edge of the light-transmission characteristics G3 of FIG. 6.

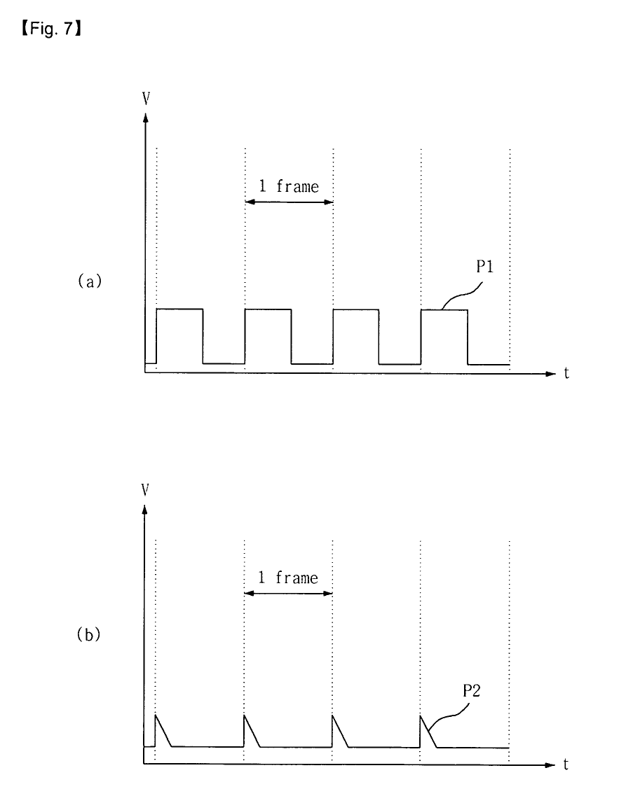

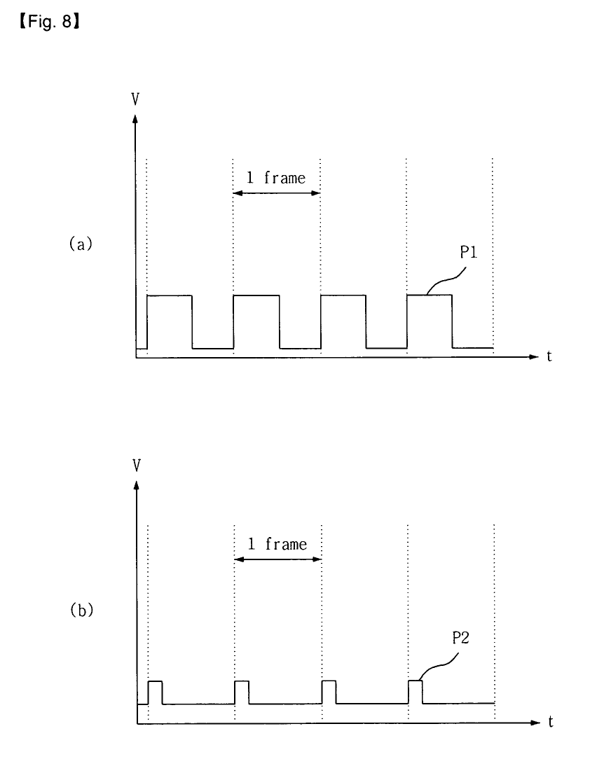

FIGS. 7 and 8 illustrate graphs showing examples of a reference signal and an active signal of the backlight driving pulse of FIG. 6. The reference signal P1 of the backlight driving pulse G1 is an AC (Alternating Current) signal in which a high voltage level and a low voltage level are alternatively repeated.

FIG. 7 shows an example in which the active signal P2 of the backlight driving pulse G1 has a saw-tooth waveform. FIG. 8 shows an example in which the active signal P2 of the backlight driving pulse G1 has a rectangular waveform.

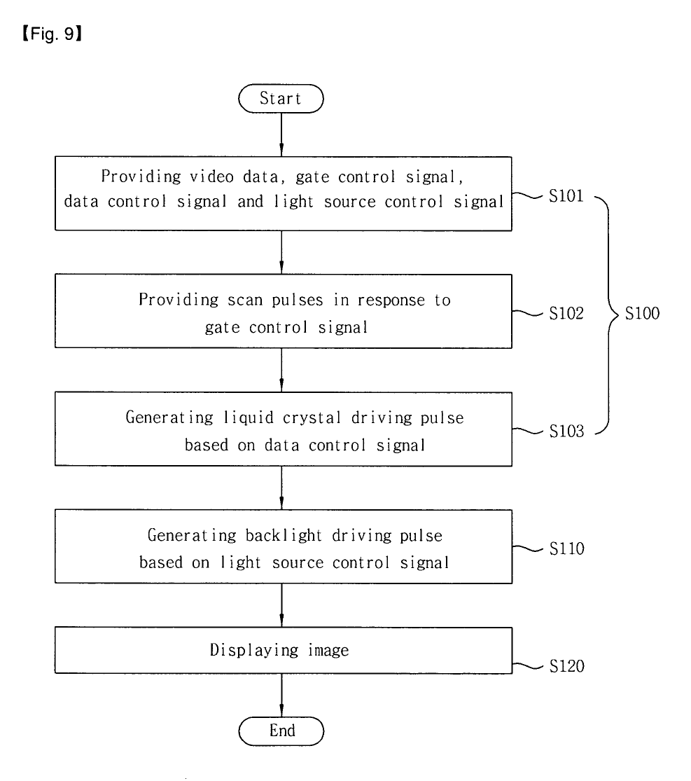

FIG. 9 illustrates a flow chart showing a method for driving a liquid crystal display according to an embodiment of the present invention. As shown in FIG. 9, the method for driving a liquid crystal display includes a step S100 during which the driver circuit 200 generates the liquid crystal driving pulse G2, a step S110 during which the backlight unit 300 generates the backlight driving pulse G1, and a step S120 during which an image is displayed on the liquid crystal panel 100.

In the step S100, the driver circuit 200 generates the liquid crystal driving pulse which, in each frame period, includes a normal data signal and a blanking signal. The step S100 may be divided into steps S101 through S103.

First, in step S101, the timing controller 230 provides a gate control signal GDC to control the gate driver 210 and a data control signal DDC to control the source driver 220. The timing controller 230 also provides the video data (R, G, B) to the source driver 220. In addition, the timing controller 230 generates the light source control signal BDC to control the backlight unit 300 based on the active lamp method or the scanning backlight method.

Next, in step S102, the gate driver 210 provides a plurality of scan pluses to the gate lines GL of the liquid crystal panel 100 in response to the gate control signal GDC from the timing controller 230.

Next, in step S103, the source driver 220 generates the liquid crystal driving pulse which, in each frame period, includes the normal data signal and the blanking signal. The source driver 220 provides the liquid crystal driving pulse to the data lines DL of the liquid crystal panel 100 in response to the data control signal DDC from the timing controller 230.

The normal data signal represents a gamma voltage corresponding to red (R), green (G), and blue (B) video data. The blanking signal represents a gamma voltage having a black level corresponding to black video data.

Each frame period of the liquid crystal driving pulse includes a data period (T1) and a blanking period (T2) as shown, for example, in FIG. 3. The normal data signal is output as the liquid crystal driving pulse during the data period (T1) and the blanking signal is output as the liquid crystal driving pulse during the blanking period (T2).

In the step S110, the light source controller 260 generates the backlight driving pulse G1 synchronized with the liquid crystal driving pulse G2 as shown, for example, in FIG. 3. The backlight driving pulse includes an active signal and a reference signal. Each frame period of the backlight driving pulse is divided into an active period (T3) and a reference period (T4). The backlight unit 300 maintains a substantially constant brightness level with the backlight driving pulse G1 as shown, for example, in FIG. 3, or alternatively uses the scanning backlight method to turn on and off periodically as shown, for example, in FIG. 6.

The driver circuit 200 outputs the active signal and the reference signal of the backlight driving pulse. The active signal should be output within the data period (T1) of the liquid crystal driving pulse G2. In addition, the active period (T3) during which the active signal is output should be within the data period (T1). Since the light transmission characteristics at the falling edges of the liquid crystal driving pulse G2 may deteriorate if the active signal is output at the falling edges, the active period (T3) should be narrow enough to be included within the data period (T1).

The active signal of the backlight driving pulse may include a saw-tooth wave as shown, for example in FIG. 4, or a rectangular wave as shown, for example in FIG. 5. The width of the active signal is substantially narrower than one frame period.

In the step S120, an image, which has a light transmittance that varies depending upon the liquid crystal driving pulse and the backlight driving pulse, is displayed on the liquid crystal panel 100.

Thus, the backlight unit 300 of the liquid crystal display, into which the black data are inserted, is controlled with the backlight driving pulse. The backlight driving pulse can alternatively activate the backlight unit 300 or turn the backlight unit 300 on and off within one frame period. The light source in the backlight unit 300 is controlled based on the response characteristics of the liquid crystal. Thus, the deterioration of the brightness due to the black-data insertion method may be prevented, and the response time of the liquid crystal may be improved. Specifically, the response time at the rising edges may be enhanced, and the lagging (or increase) of the response time at the falling edges may be prevented.

The liquid crystal display according to the example embodiments of the present invention adopts both a backlight driving method, by which the brightness of the backlight unit is actively controlled, and the black-data insertion method. As a result, the brightness and the response time of the liquid crystal display are enhanced. In addition, the method for driving the liquid crystal display according to an example embodiment of the present invention may drive the liquid crystal display more efficiently and effectively.

It will be apparent to those skilled in the art that various modifications and variations can be made in the liquid crystal display and a method for driving the same according to the present invention without departing from the spirit or scope of the invention. Thus, it is intended that the present invention cover the modifications and variations of this invention provided they come within the scope of the appended claims and their equivalents.

What is claimed is:

1. A liquid crystal display comprising:
a driver circuit configured to generate at least one liquid crystal driving pulse and at least one backlight driving pulse, wherein the liquid crystal driving pulse includes a normal data signal and a blanking signal, and the backlight driving pulse includes an active signal and a reference signal;
a backlight unit configured to generate light in response to the backlight driving pulse; and
a liquid crystal panel configured to display an image having a light transmittance that varies depending upon the liquid crystal driving pulse and the backlight driving pulse.

2. The liquid crystal display of claim 1, wherein the blanking signal corresponds to a gamma voltage having a black level.

3. The liquid crystal display of claim 1, wherein a frame period of the liquid crystal driving pulse is divided into a data period and a blanking period, and the driver circuit is configured to generate the normal data signal during the data period and the blanking signal during the blanking period.

4. The liquid crystal display of claim 3, wherein the driver circuit is configured to generate the active signal of the backlight driving pulse during the data period.

5. The liquid crystal display of claim 4, wherein the driver circuit is configured to generate the active signal after generating the normal data signal.

6. The liquid crystal display of claim 3, wherein a frame period of the backlight driving pulse is divided into an active period and a reference period, and the driver circuit generates the active signal and the reference signal during the active period and the reference signal during the reference period.

7. The liquid crystal display of claim 6, wherein a start point and an end point of the active period are within the data period.

8. The liquid crystal display of claim 1, wherein the reference signal of the backlight driving pulse is a DC (Direct Current) signal.

9. The liquid crystal display of claim 1, wherein the reference signal of the backlight driving pulse is an AC (Alternating Current) signal in which a high level and a low level are alternated repeatedly.

10. The liquid crystal display of claim 9, wherein the active signal of the backlight driving pulse is output during a period in which the high level of the AC signal is active.

11. The liquid crystal display of claim 1, wherein the active signal of the backlight driving pulse is a square wave.

12. The liquid crystal display of claim 1, wherein the active signal of the backlight driving pulse is a saw-tooth wave.

13. The liquid crystal display of claim 1, wherein the driver circuit includes:
a timing controller configured to provide video data, a gate control signal, a data control signal, and a light source control signal;
a gate driver configured to provide a plurality of scan pulses to respective gate lines of the liquid crystal panel in response to the gate control signal;
a source driver configured to provide the at least one liquid crystal driving pulse to at least one data line of the liquid crystal panel in response to the data control signal; and
a light source controller configured to generate the at least one backlight driving pulse based on the light source control signal to control the backlight unit.

14. A method for driving a liquid crystal display, the method comprising steps of:
generating at least one liquid crystal driving pulse, wherein the liquid driving pulse includes a normal data signal and a blanking signal;
generating at least one backlight driving pulse, wherein the backlight driving pulse includes an active signal and a reference signal; and
displaying an image on the liquid crystal display having a light transmittance that varies depending upon the liquid crystal driving pulse and the backlight driving pulse.

15. The method of claim 14, wherein the blanking signal corresponds to a gamma voltage having a black level.

16. The method of claim 14, wherein a frame period of the liquid crystal driving pulse is divided into a data period and a blanking period, and the driver circuit generates the normal data signal during the data period and the blanking signal during the blanking period.

17. The method of claim 16, wherein the active signal of the backlight driving pulse is generated during the data period.

18. The method of claim 17, the active signal is generated after the normal data signal is generated.

19. The method of claim 16, wherein a frame period of the backlight driving pulse is divided into an active period and a reference period, and the driver circuit generates the active signal and the reference signal during the active period and the reference signal during the reference period.

20. The method of claim 19, wherein a start point and an end point of the active period are within the data period.

21. The method of claim 14, wherein the reference signal of the backlight driving pulse is a DC (Direct Current) signal.

22. The method of claim 14, wherein the reference signal of the backlight driving pulse is an AC (Alternating Current) signal in which a high level and a low level are alternatively repeated.

23. The method of claim 22, wherein the active pulse of the backlight driving pulse is output during a period in which the high level of the AC signal is active.

24. The method of claim 14, wherein the active signal of the backlight driving pulse is a square wave.

25. The method of claim 14, wherein the active signal of the backlight driving pulse is a saw-tooth wave.
